(19) United States
(12) Patent Application Publication
(10) Pub. No.: US 2024/0408713 A1
(43) Pub. Date: Dec. 12, 2024

(54) METHOD FOR ASSIGNNG AN EMERGENCY-STOP FUNCTIONALITY, AND AUTOMATION SYSTEM

(71) Applicant: KUKA Deutschland GmbH, Augsburg (DE)

(72) Inventor: Yevgen Kogan, Augsburg (DE)

(73) Assignee: KUKA Deutschland GmbH, Augsburg (DE)

(21) Appl. No.: 18/719,655

(22) PCT Filed: Dec. 5, 2022
(86) PCT No.: PCT/EP2022/084395

§ 371 Date: Jun. 13, 2024

(30) Foreign Application Priority Data
Dec. 17, 2021 (DE) 10 2021 133 582.5

(51) Int. Cl. B23Q 15/007

(52) U.S. Cl. CPC B23Q 15/007

(57) ABSTRACT

A method and an automation system for assigning an emergency-stop device to at least one robot system that includes at least one robot and/or machine, wherein the assigned robot system is stopped upon actuation of the emergency-stop device. The assignment of the emergency-stop device can be removed from a first assigned robot system and assigned to a second robot system, e.g., if the emergency-stop device is moved between the robot systems (hand-held operating apparatus vehicle. In the method, the emergency-stop device is assigned to a selected range of effectiveness of a robot system, and the emergency-stop device is integrated into the relevant safety circuit of that robot system which is within the selected range of effectiveness.

### CROSS-REFERENCE TO RELATED APPLICATIONS

This application is a national phase application under 35 U.S.C. § 371 of International Patent Application No. PCT/EP2022/084395, filed Dec. 5, 2022 (pending), which claims the benefit of priority to German Patent Application No. DE 10 2021 133 582.5, filed Dec. 17, 2021, the disclosures of which are incorporated by reference herein in their entirety.

### TECHNICAL FIELD

The invention relates to a method for assigning an emergency-stop functionality between at least one emergency-stop device and at least one robot system. The invention also relates to an automation system for carrying out the method.

### BACKGROUND

DE 10 2016 107 564 A1 describes a safety device for a production station for workpieces, in particular body components, and for a conveyor that can be moved into and out of the production station for transporting the workpieces into and out of the production station, wherein the production station and the conveyors each have their own controller and their own safety circuit, and wherein the safety device connects the safety circuits of the production station and of the conveyor located in the production station. For this purpose, a recognition device can be provided which has a detection means which carries out the recognition of the conveyor. The detection means is arranged, for example, at a lock in a protective partition of the production station. The axial distance in the direction of travel is so large, given the corresponding lock length, that the conveyor in the central lock position does not trigger any of the detection means.

### SUMMARY

The object of the invention is to provide a method for assigning an emergency-stop functionality between at least one emergency-stop device and at least one robot system, which enables a particularly simple and flexible assignment. A further object is to create an automation system that allows a particularly simple and flexible assignment of an emergency-stop functionality between at least one emergency-stop device and at least one robot system of the automation system.

The object is achieved by a method for assigning an emergency-stop functionality between at least one emergency-stop device and at least one robot system, comprising the steps of:
starting an initialization routine which is designed and configured to integrate an emergency-stop device assigned to the initialization routine into a safety circuit of a specific robot system from a number of several robot systems of a common automation system,
retrieving data containing information about the current spatial localization and the current configuration of at least one robot system of the several robot systems within the common automation system from a digital process model of the automation system, wherein
the digital process model contains configuration data which describe common and/or separate ranges of effectiveness of the several robot systems within the common automation system,
manually or automatically assigning the emergency-stop device, which is to be integrated into the safety circuit of a specific robot system by means of the started initialization routine, to a range of effectiveness selected from several ranges of effectiveness of the digital process model,
integrating the emergency-stop device into the safety circuit of the robot system which lies within the selected range of effectiveness of the digital process model.

In general, the robot system can, for example, have only a single robot. The robot generally comprises a robot arm and a robot controller. The robot system can, however, also comprise several robots or at least several robot arms. Two or more robot arms can also be controlled by a common controller if necessary. For example, a group controller, a production controller, or a factory controller can be connected to at least one of the robots. Each robot system can have additional automatically controllable machines besides the at least one robot. For example, the robot arm can have an automatically controlled tool that is handled by moving the robot arm. The at least one robot can also be assigned machines, devices, or apparatuses separate from the robot arm. These can, for example, be automatically drivable conveyors, locks, positioners, and/or machine tools. Each robot system can also be assigned a vehicle, in particular an automatically driven and/or autonomous vehicle. The vehicle can, for example, also carry its own robot arm.

According to DIN EN ISO 10218-2, every robot system must meet the safety requirements described therein. These include stop functions on the robot system or on robot cells, which must also have an emergency-stop function as described there in order to be able to stop all robot movements and other hazardous functions in the cell or at the interfaces to other regions in the event of danger.

The emergency-stop function of robots must meet the requirements of DIN EN ISO 10218-1 and, among other things, have an emergency-stop device in accordance with DIN EN (IEC) 60204-1. Electrical or electronic control circuits which are designed and equipped to meet the safety requirements are also referred to below as safety circuits.

The assignment of the emergency-stop functionality between the at least one emergency-stop device and the at least one robot system can be achieved by integrating the emergency-stop device, e.g., an emergency-stop apparatus according to DIN EN (IEC) 60204-1, into the safety circuit of the at least one robot system. Such integration can be achieved by connecting the emergency-stop device electrically and functionally to the safety circuit of the robot system using safe technology. Through such an electrical and functional connection, the robot system can be automatically transferred to a safe state, particularly when the integrated emergency-stop device is triggered manually, so that no imminent danger can arise from the robot system (and from other machines possibly assigned via the common safety circuit). Other machines or robot systems that are not integrated into the relevant safety circuit are not affected when an emergency-stop device integrated into the relevant safety circuit is triggered; in particular, they are not brought to a standstill or brought into a stopped safe state, but can continue their planned work unaffected.

The emergency-stop device not only refers to an electromechanical input means that serves as an actuating means for manual triggering, but the emergency-stop device comprises an associated electrical and/or electronic circuit that is designed and configured to bring about an automatic shutdown of all machines, robots, and other devices that are connected to the common safety circuit of the emergency-stop device. For example, an emergency stop can also be triggered fully automatically, e.g., by means of an electrical signal indicating the emergency stop request, which is automatically sent within the safety circuit when a fault is automatically detected—for example, by a safety controller.

Before starting the initialization routine to carry out the method, the following preparatory steps can be performed:

Before carrying out a production step, it must be determined which plant components and/or robot systems are required for the planned automated production steps. It makes sense for the plant components and/or robot systems to be located at a closer distance to each other. The appropriate spatially effective ranges of the plant components and/or robot systems can be derived from the planned production steps and the local arrangement of the plant components and/or robot systems in relation to one another. The appropriate spatially effective ranges can in particular be determined automatically, e.g., by means of a configuration algorithm that is executed automatically and—for example, as a function of a process description, such as a manufacturing process description or an assembly process description-selects the resources required for each, such as machines, system components, and/or robots, and links them together in terms of control technology. The configuration algorithm can name the machines, system components, and/or robots and suggest their sensible, possibly optimal, positions in a system region so that the machines, system components, and/or robots can be arranged accordingly. Alternatively, machines, system components, and/or robots already present in the system can be automatically determined, and, based upon their already specified positions and locations within the system region, at least one associated effective range can be automatically defined.

Subsequently, at least one emergency-stop device can be selected or determined manually or automatically, e.g., by the configuration algorithm described above, which is located within or at least in the vicinity of the effective range and whose safety-related assignment to the above-mentioned system components and/or robot systems is determined. This may mean that the emergency-stop device is only determined based upon the given spatial position of the relevant automation components (system parts and/or robot systems).

If no emergency-stop device is present within an initially defined effective range, a signal can be generated automatically which at least provides information that an emergency-stop device is not present and/or that an emergency-stop device is present, but no emergency-stop device has yet been assigned to the initially defined effective range. If it can be automatically determined that an emergency-stop device is present but is located outside the initially defined effective range, it can be provided that the initially defined effective range be automatically extended so that the emergency-stop device that was previously outside is now within the thus extended effective range.

Accordingly, there can be two variants of the method. Either the effective ranges are defined in advance, and the emergency-stop devices are permanently assigned to them. Here, only the system components and/or robot systems have to be dynamically assigned to the effective ranges. Or, no effective ranges are defined initially. These are then determined automatically in advance or during the runtime of the respective process steps, also automatically, depending upon which resources are required for a step, and, finally, appropriate emergency-stop devices are assigned to the effective ranges.

For effective ranges derived from a process description, at least one operating station should be located within an effective range. If this is not the case, the effective range may have to be selected to be larger than would be physically necessary, in order to include a more distant station, which would then have at least one operating station with an emergency-stop device. Alternatively, a person can also be informed automatically, e.g., based upon information automatically presented on a display, that an operating station with an emergency-stop device must be placed and configured in the specified effective range. The latter can be done either immediately before execution or during the planning of the process steps. Since such an operating station is always operated by people anyway, this operating station should actually only be present when a person is nearby, i.e., the effective range may, if necessary, be entered only with an operating station that includes an emergency-stop device.

Since an operating station which includes the required emergency-stop device can be a portable, i.e., mobile, operating station, such as a hand-held control device of a robot, the person can automatically be asked to bring a mobile operating station with them if they wish to enter the defined effective range. An automatic monitoring device can also be provided, e.g., corresponding electrical sensors at the boundaries of the effective range, which monitoring device not only monitors the entry of a person into the effective range, but also monitors whether the person entering is carrying a mobile operating station. For example, each mobile operating station used can have an identifier which can be detected by the monitoring device in order to automatically determine the presence or absence of a specific mobile operating station. The identifier can be read automatically, for example, by an RFID tag, or the identifier can be recorded by the control system, since the mobile operating station must be connected to a machine, system component, and/or a robot in order to be used at all. The monitoring device can query this automatically if necessary. If, for example, the monitoring device detects that a person enters the effective range without carrying a mobile operating station, i.e., the person does not have at least one emergency-stop device, the machines, system components, and/or robots in this effective range can be immediately and automatically transferred to a safe state.

The process model can also be created and/or modified at runtime. This may mean that the effective ranges are not defined in the model from the beginning, but are only calculated at runtime.

The initialization routine for carrying out the method can be started manually or automatically. The initialization routine can be started manually, for example, by manually operating an input device—for example, on a hand-held device or an operating panel of a control device. Automatic starting can occur, for example, if a suitably configured sensor on the robot system in question automatically detects the approach of a new system part that has the emergency-stop device to be integrated. The emergency-stop device of the new system part is assigned to the initialization routine so that this emergency-stop device can be integrated into the safety circuit of the specific robot system.

In automation systems that include several robot systems, integrating an emergency-stop device for a new system component is not easy, or has so far only been possible with great effort due to the complexity of the multiple robot systems. With the method according to the invention, a specific robot system can be integrated from a number of several robot systems very easily and quickly.

For this purpose, the method retrieves data containing information about the current spatial localization and the current configuration of at least one robot system of the several robot systems within the common automation system from a digital process model of the automation system.

The digital process model is distinguished in that it depicts several robot systems of the automation system, in terms of both their current spatial localization and their current configurations. Instantaneous spatial localization plays a particularly important role in mobile systems, such as autonomous vehicles or mobile robots, but is also important for stationary robots and robot systems. For example, a large number of robots can be stationary in an automation system, with a first subgroup of robots and/or machines working together or performing coordinated movements in a first configuration, such as in automatic presses and robots for press linking, and another subgroup of robots and/or machines working together or performing coordinated movements in a second configuration. In such cases, a very specific robot can then, for example, be assigned to one of the first subgroups of robots and/or machines for a first period of time and to another (second) subgroup of robots and/or machines for a second period of time. If this specific robot is served, for example, by a mobile vehicle, e.g., a transport vehicle for workpieces or tools, the mobile vehicle must be assigned to the safety circuit of the first subgroup of robots and/or machines in the first period of time and, in contrast, assigned to a different safety circuit of the second subgroup of robots and/or machines in the second period of time. The robots and/or machines can therefore be grouped together into a group or subgroup, in particular if they are located in spatial proximity to one another.

The current configuration of at least one robot system of the several robot systems can therefore include data about the current affiliation of the robot system with a specific safety circuit. The specific safety circuit can be determined by the range of effectiveness of the controller or controllers of the respective group of robots and/or machines. The respective range of effectiveness can be determined according to the requirements of DIN EN ISO 10218-2 (5.3.8.2). The range of effectiveness can also result from the manner in which robots and/or machines work together within a robot system, as can be defined, for example, by process descriptions or manufacturing instructions within the digital process model. The assignment of a range of effectiveness can therefore result not only from the current spatial localization of the robot systems, but, alternatively or additionally, also from the manner in which robots and/or machines work together. Two or more ranges of effectiveness can overlap. In the case of overlapping ranges of effectiveness, the emergency-stop device of the new system part can be integrated into these two or more ranges of effectiveness simultaneously.

The digital process model can therefore contain configuration data that describe common and/or separate ranges of effectiveness of the several robot systems within the common automation system. The common and/or separate ranges of effectiveness can be dynamic, i.e., the respective current assignment of a robot system to a certain range of effectiveness or the definition of the range of effectiveness as such over a certain number of robots and/or machines can change over time. In modern automation systems, such a dynamic assignment can be very dynamic, i.e., a change can occur within hours or minutes-theoretically, even in seconds or less. With the method according to the invention, a new system part being added can be immediately integrated into the required safety circuit.

The emergency-stop device of the new system part being added is assigned to the selected range of effectiveness from several ranges of effectiveness of the digital process model. The range of effectiveness, i.e., the safety circuit into which the emergency-stop device of the new system part being added is to be integrated, can either be selected manually or selected automatically.

In a simple case, the current configuration of all ranges of effectiveness, i.e., all safety circuits of the multiple robot systems, can be shown to a robot operator, e.g., on a display, and the operator can manually select a specific range of effectiveness or a specific safety circuit from the ranges of effectiveness or safety circuits displayed, e.g., by tapping the safety circuit on the display or selecting via input means, such as a keyboard, from a menu that represents the ranges of effectiveness or the safety circuits.

Alternatively, the range of effectiveness, i.e., the safety circuit into which the emergency-stop device of the new system part being added is to be integrated, can be selected automatically, e.g., if a suitably configured sensor on the robot system in question automatically detects the approach of a new system part being added which comprises the emergency-stop device to be integrated. The emergency-stop device of the new system part is automatically integrated into the safety circuit of the robot system in question, based upon the sensor detection.

Both in the design variant with a manual selection of the range of effectiveness or the safety circuit into which the emergency-stop device is to be integrated, and in the automatic design variant, after the selection according to the procedure, the emergency-stop device is integrated into the safety circuit of the robot system which lies within the selected range of effectiveness of the digital process model.

Such integration takes place automatically, e.g., in an analogous manner, as was already known after manually connecting a wired, hand-held control device, which comprises an emergency-stop device, to a robot controller.

In a development of the method, the digital process model can comprise data of a production process in which, for at least one production step, an interaction of at least one first machine, a first robot, or a first robot system with at least one second machine, a second robot, or a second robot system is planned at a specific spatial localization at a specific point in time or for a specific period of time, wherein a common range of effectiveness is defined for this production step at least for the planned point in time or the planned period of time, and, in the manual or automatic assignment of the emergency-stop device to a selected range of effectiveness, the common range of effectiveness defined on the basis of the production process is used.

The ranges of effectiveness can be calculated based upon the process description, in particular based upon the space requirement of the machines and/or robots selected for execution of the process. This means that, in this embodiment, the ranges of effectiveness are not rigidly defined in advance, but can be changed dynamically during the execution.

The digital process model is therefore constituted by data which, among other things, include values about the current spatial localization of the machines, robots, and/or robot systems involved in the production process, as well as values which reflect the current configuration of the machines, robots, and/or robot systems in detail and also in their respective working relationship to one another. A working relationship in the production process can, for example, define how a first robot and a second robot interact or collaborate to carry out a specific production step or several production steps, such as manufacturing steps or assembly steps.

The digital process model can be dynamic. This means that the values relating to the current spatial localization of the machines, robots, and/or robot systems involved in the production process and/or the values relating to the current configuration of the machines, robots, and/or robot systems can be variable, i.e., can be different in a first time period from the values during a second time period different from the first time period.

To meet the requirements of DIN EN ISO 10218-2, the ranges of effectiveness of the controller, or of the several controllers, must be clearly defined. The ranges of effectiveness can be defined in the digital process model. Likewise, the ranges of effectiveness can be defined separately from the digital process model, wherein the data and values from the digital process model can be merged with the ranges of effectiveness stored elsewhere and/or the assignments of the ranges of effectiveness in order to be able to manually or automatically assign the emergency-stop device to a selected range of effectiveness.

The digital process model can include data from a production process in which the ranges of effectiveness of several machines, robots, and/or robot systems are defined differently for different points in time or different periods of time.

The ranges of effectiveness can be stored dynamically with respect to the data of the production process. This means that the values relating to the current ranges of effectiveness of the machines, robots, and/or robot systems involved in the production process can be set variably, i.e., they can be set differently in a first time period than the values during a second time period different from the first time period.

It is possible that the effective ranges are not defined from the outset, but are determined automatically based upon the machines and robots required to carry out a process, or their positions. In a first step, it is possible to determine which machines and robots are needed in a process step. In a second step, the space that each machine may occupy during process execution is determined. In a third step, the range of effectiveness is defined as the union of the relevant individual spaces for all machines and robots involved in the process step. Optionally, it can also be checked whether at least one operating station with an emergency-stop device is available in the joint range of effectiveness thus determined.

At least one machine, at least one robot, and/or at least one robot system can be designed as a mobile system having an emergency-stop device, wherein the current spatial localization of the mobile system is used for manually or automatically assigning the emergency-stop device of the mobile system to a range of effectiveness selected from the digital process model.

The mobile system can be a mobile vehicle—for example, a transport vehicle for workpieces or tools. Alternatively, the mobile system can be a mobile robot. The mobile robot may have an automatically moving platform on which a robot arm is positioned. The vehicle may be an autonomous vehicle. However, the mobile system can also be formed by a so-called linear axis, which can, for example, have fixedly installed rails on which a carriage can be automatically adjusted in a linear movement, wherein a robot arm can be positioned on the carriage. Other mobile systems can, for example, be conveyor systems or lock systems by means of which workpieces, tools, or other production means can be fed for processing in the respective robot cell. Each of these mobile systems is equipped with its own emergency-stop device.

The initialization routine can be started manually or by a human input command. In this way, certain emergency-stop devices can be integrated directly into a range of effectiveness by one person. This can occur, for example, when a mobile vehicle, such as a mobile robot, has been manually driven by a person in manual mode to a specific robot system and is to be manually connected to the robot system there by the person—for example, in the interface region of a robot cell.

The initialization routine can be started automatically, and the assignment of the emergency-stop device to a selected range of effectiveness can be carried out automatically. In such a case, for example, an autonomous vehicle can independently drive into the interface region of a robot cell and can be automatically initialized there, in order to integrate itself into the safety circuit of the range of effectiveness of this robot cell. For this purpose, the autonomous vehicle can automatically register with the robot system in question, and/or a sensor can be installed on the robot system or on the robot cell, which automatically detects the approach or arrival of the autonomous vehicle to the robot cell and automatically initiates the initialization routine.

The initialization routine can therefore be started automatically, and the assignment of the emergency-stop device to a selected range of effectiveness can be carried out automatically if a robot system having the emergency-stop device to be assigned detects, by means of its own sensor, the other robot system into whose safety circuit the emergency-stop device of the one robot system is to be integrated.

The initialization routine can be started automatically, and the assignment of the emergency-stop device to a selected range of effectiveness can be carried out automatically as soon as a first protective field of a first machine, a first robot, or a first robot system that is predefined or derived from a process description overlaps with a predefined second protective field of a second machine, a second robot, or a second robot system.

The respective protective field can, for example, be a geometric area stored in the form of digital data, which geometric area is stored in a digital map in the process model. For example, a protective field can already be completely defined by a specific fixed point on the respective robot system and a predetermined radius length if the protective field is formed by a circular area or circular line that completely encloses the robot system. An overlap of a first protective field with a second protective field or another protective field can be determined mathematically using generally known calculation methods, which are also known, for example, from collision calculation. However, the respective protective field does not necessarily have to be circular or correspond to a general geometric shape, but can also have any contours. In the case of a mobile robot system, such as a vehicle, the protective field can be defined as stationary relative to the mobile robot system or the vehicle, i.e., the protective field can move when the mobile robot system or the vehicle moves. Protective fields on mobile systems can already be present in a known manner as a collision monitoring device and can, for example, be designed and configured to automatically stop a movement of the mobile robot system or the vehicle if a collision is imminent, e.g., if a person enters the protective field or an obstacle, in particular a fixed obstacle, appears in the protective field due to the movement of the robot system or due to the driving of the vehicle.

The predefined first protective field of the first machine, the first robot, or the first robot system and/or the predefined second protective field of the second machine, the second robot, or the second robot system can be assigned to and/or correspond to a range of effectiveness defined in the digital process model.

The object is also achieved by an automation system, having at least one first robot system with a first safety circuit and at least one second robot system with a second safety circuit and a system controller, which comprises a digital process model in which the at least one first robot system and the at least one second robot system are mapped, wherein the system controller is designed and configured to carry out a method according to one of the described embodiments.

Specific exemplary embodiments of the invention are explained in more detail in the following description with reference to the accompanying drawings. Specific features of these exemplary embodiments, optionally considered individually or in further combinations, can represent general features of the invention, regardless of the specific context in which they are mentioned.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 shows a flowchart of the steps in an exemplary basic method according to the present disclosure,

FIG. 2 shows a schematic representation of the integration of an emergency-stop device of a third robot optionally into a first safety circuit of a first robot system or a second safety circuit of a second robot system based upon a process model,

FIG. 3 shows a schematic representation of an automation system with a first robot system having a plurality of individual robots and a plurality of workpiece positioners, and a second robot system having a plurality of individual robots and a plurality of workpiece positioners, as well as an autonomous vehicle,

FIG. 4 shows schematic representations of various possible robot systems that can be integrated into a safety circuit either individually or together, and

FIG. 5 shows a schematic representation of a vehicle as a mobile robot system surrounding a protective field, and stationary robot systems having their own protective fields.

### DETAILED DESCRIPTION

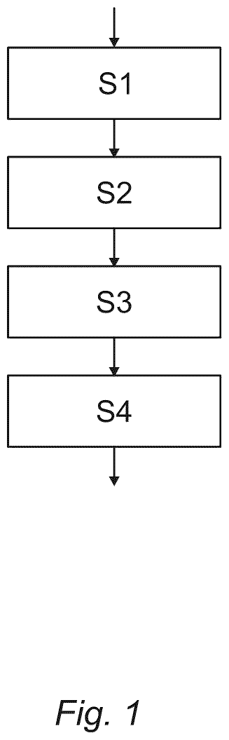

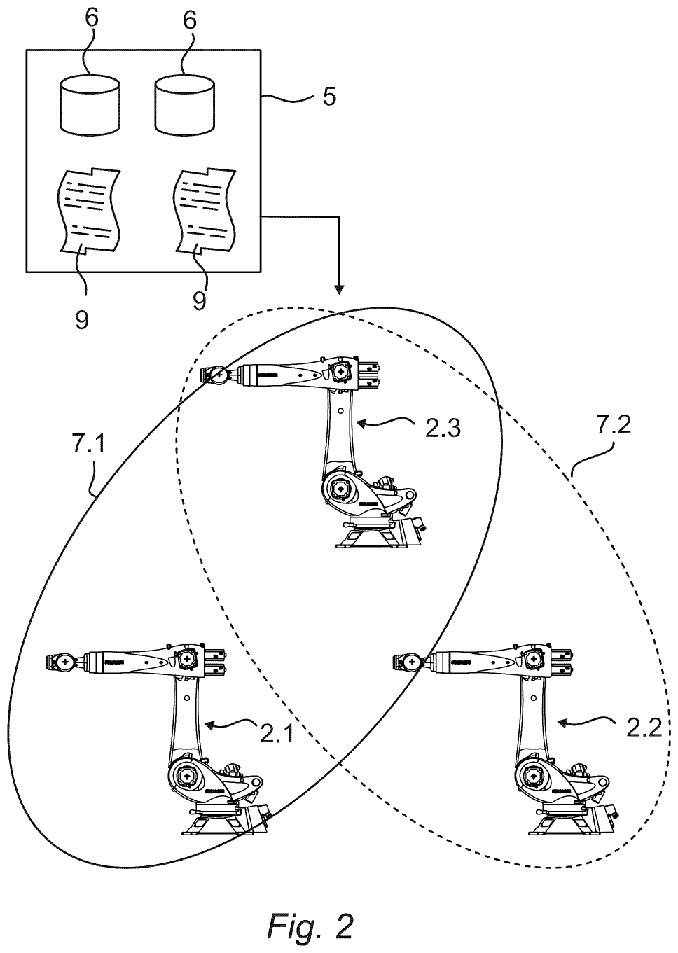

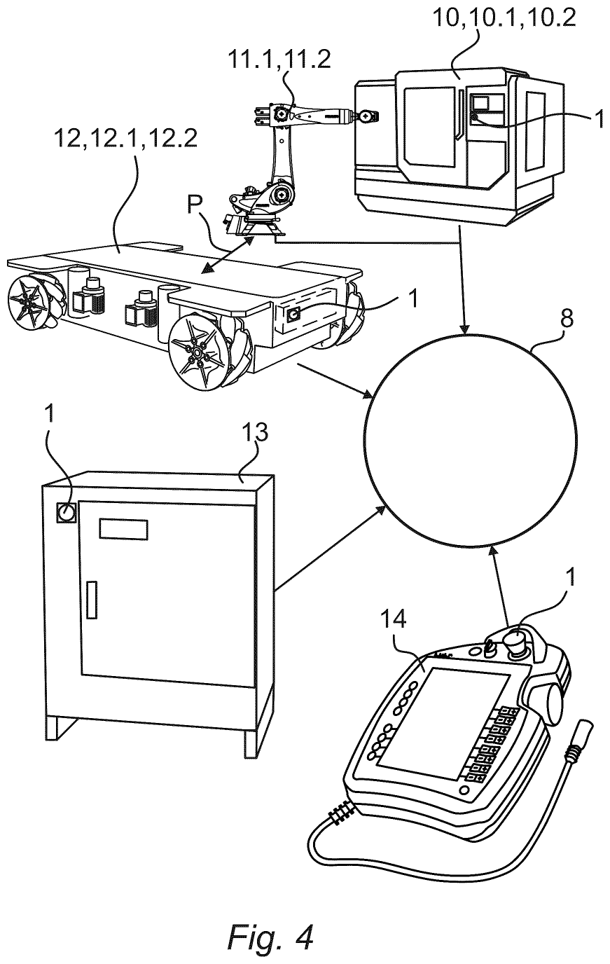

FIG. 1 schematically shows an exemplary method for assigning an emergency-stop functionality between at least one emergency-stop device 1 (FIG. 4) and at least one robot system 2 (FIG. 2).

In a first step S1 of the method, an initialization routine is started which is designed and configured to integrate an emergency-stop device 1 assigned to the initialization routine into a safety circuit 3 of a specific robot system 2.3 from a number of several robot systems 2.1, 2.2, 2.3 of a common automation system 4.

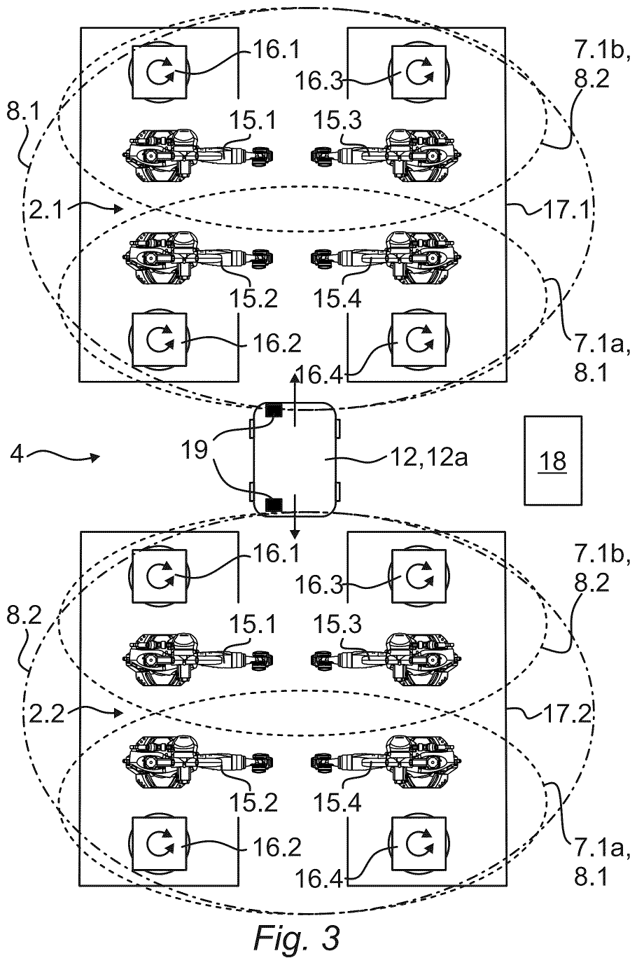

In a second step S2 of the method, data containing information about the current spatial localization and the current configuration of at least one robot system 2.3 of the several robot systems 2.1, 2.2, 2.3 within the common automation system 4 are then retrieved from a digital process model 5 of the automation system 4 (FIG. 3).

The digital process model 5 contains configuration data 6 which describe common and/or separate ranges of effectiveness 7.1, 7.2 of the several robot systems 2.1, 2.2, 2.3 within the common automation system 4.

In a third step S3 of the method, the emergency-stop device 1, which is to be integrated into the safety circuit 8 (FIG. 4) of a specific robot system 2.3 by means of the started initialization routine S1, is manually or automatically assigned to a range of effectiveness 7.1 selected from several ranges of effectiveness 7.1, 7.2 of the digital process model 5.

In a fourth step S4 of the method, the emergency-stop device 1 is integrated into the safety circuit 8 of the robot system 2.1, which lies within the selected range of effectiveness 7.1 of the digital process model 5.

The digital process model 5 can comprise data of a production process in which, for at least one production step 9 (FIG. 2), an interaction of at least one first machine 10.1, a first robot 11.1, or a first robot system 2.1 with at least one second machine 10.2, a second robot 11.2, or a second robot system 2.2 is planned at a specific spatial localization at a specific point in time or for a specific period of time, wherein, for this production step 9, at least for the planned point in time or the planned period of time, a common range of effectiveness 7.1, 7.2 is defined or is automatically determined based upon the spatial requirement of the machines required for execution, and, in the manual or automatic assignment of the emergency-stop device 1 to a selected range of effectiveness 7.1, the common range of effectiveness 7.1 defined on the basis of the production process is used.

The machine or the robot can also be formed by a first vehicle 12.1 or a second vehicle 12.2.

The digital process model 5 can comprise data of a production process in which the ranges of effectiveness 7.1, 7.2 of several machines 10.1, 10.2, robots 11.1, 11.2, and/or robot systems 2.1, 2.2, 2.3 are defined differently for various points in time or various periods of time.

The new system part being added to the safety circuit 8 of the robot system 2.1, which lies within the selected range of effectiveness 7.1 of the digital process model 5, can, as shown schematically in FIG. 4, among other things, be designed as a mobile system 12 which has an emergency-stop device 1, wherein the current spatial localization of the mobile system 12 can be used for the manual or automatic assignment of the emergency-stop device 1 of the mobile system 12 to a range of effectiveness 7.1 selected from the digital process model 5 (FIG. 2).

The mobile system 12 can, for example, be equipped with a robot 11.1, 11.2, i.e., carry and move it, as indicated by the arrow P in FIG. 4. Alternatively, the robot 11.1, 11.2 can also be assigned to another machine 10.1, 10.2 in terms of process technology, such as the machining center 10 shown in FIG. 4. The machining center 10 itself represents a robot system, on the one hand, when it cooperates with the robot 11.1, 11.2 in terms of process technology, but also, on the other hand, when the machining center 10 is regarded as a freely programmable, multi-axis automation machine that can be programmed and moved by a control device—for example, in at least three degrees of freedom (axes).

However, a robot controller 13, which is designed and configured to control a robot 11.1, 11.2, can also be integrated into the selected safety circuit 8. Alternatively, a separate hand-held control device 14, which comprises an emergency-stop device 1, can be integrated into the selected safety circuit 8.

FIG. 3 shows a representative exemplary configuration of an automation system 4 with two robot systems 2.1, 2.2, each comprising, for example, four individual robot arms 15.1, 15.2, 15.3, 15.4, as well as four individual positioners 16.1, 16.2, 16.3, 16.4. Each robot system 2.1, 2.2 is located within a cell 17.1 or 17.2.

In the case of the present exemplary embodiment of FIG. 3, the vehicle 12a can switch between the first cell 17.1 and the second cell 17.2—for example, to bring tools or workpieces to the robot arms 15.1, 15.2, 15.3, 15.4. If the vehicle 12a now changes, for example, from the first cell 17.1 to the second cell 17.2, the emergency-stop device 1 of the vehicle 12a can be removed from the first range of effectiveness 7.1 of the first cell 17.1 and integrated into the second range of effectiveness 7.2 of the second cell 17.2.

In the process model 5, for example, it can be specified that the first range of effectiveness 7.1 extend over the entire first cell 17.1. In the process model 5, it can also be specified that the second range of effectiveness 7.2 extend, for example, over the entire second cell 17.2. In such a configuration, an emergency stop triggered within the first range of effectiveness 7.1 would bring all robot arms 15.1, 15.2, 15.3, 15.4 and all positioners 16.1, 16.2, 16.3, 16.4 in the first cell 17.1 to a standstill. If the vehicle 12a is involved in the first range of effectiveness 7.1 at this moment, the vehicle 12a would also be stopped. However, if the vehicle 12a is located in the second range of effectiveness 7.2 at this moment and is integrated there, the vehicle 12a would not be brought to a standstill in the event of an emergency stop being triggered within the first range of effectiveness 7.1.

In another configuration, it can be specified in the process model 5, for example, that a first range of effectiveness 7.1a extend only over a part of the first cell 17.1, as illustrated in FIG. 3, e.g., only over the second robot arm 15.2 and the fourth robot arm 15.4, as well as the second positioner 16.2 and the fourth positioner 16.4. The first robot arm 15.1 and the third robot arm 15.3, as well as the first positioner 16.1 and the third positioner 16.4, form a second range of effectiveness 7.1b separate from the first range of effectiveness 7.1a. This can be defined accordingly in the process model 5.

In such a configuration, an emergency stop triggered within the first range of effectiveness 7.1a would bring only the robot arms 15.2 and 15.4 and the positioners 16.2 and 16.4 to a standstill. If the vehicle 12a is integrated into this first range of effectiveness 7.1a at this moment, the vehicle 12a would also be stopped if a fault occurs in the first range of effectiveness 7.1a. If, however, a fault occurs in the second range of effectiveness 7.1b, this would cause only the robot arms 15.1 and 15.3 and the positioners 16.1 and 16.3 to stop, but without the vehicle 12a being stopped, since the vehicle 12a is not in the second range of effectiveness 7.1b at that moment. Accordingly, the vehicle 12a would not be brought to a standstill in the event of an emergency stop being triggered within the second effective range 7.1b.

The automation system 4 can therefore have at least one first robot system 2.1 with a first safety circuit 8.1 and at least one second robot system 2.2 with a second safety circuit 8.2. The automation system 4 comprises a system controller 18, which has the digital process model 5 (FIG. 2) in which the at least one first robot system 2.1 and the at least one second robot system 2.2 are mapped, wherein the system controller 18 is designed and configured to carry out the method as described.

The initialization routine can be started automatically, and the assignment of the emergency-stop device 1 to a selected range of effectiveness 7.1, 7.1a, 7.1b, 7.2, 7.2a, 7.2b can be carried out automatically. The initialization routine can be started automatically, and the assignment of the emergency-stop device 1 to a selected range of effectiveness 7.1, 7.1a, 7.1b, 7.2, 7.2a, 7.2b can be carried out automatically, in particular, when a robot system 2 having the emergency-stop device 1 to be assigned, such as the vehicle 12a in the illustrated exemplary embodiment of FIG. 3, detects by means of its own sensor 19 the other robot system 2.1, 2.2, into whose safety circuit 8.1, 8.2 the emergency-stop device 1 of the one robot system or the vehicle 12a enters and there is to be integrated.

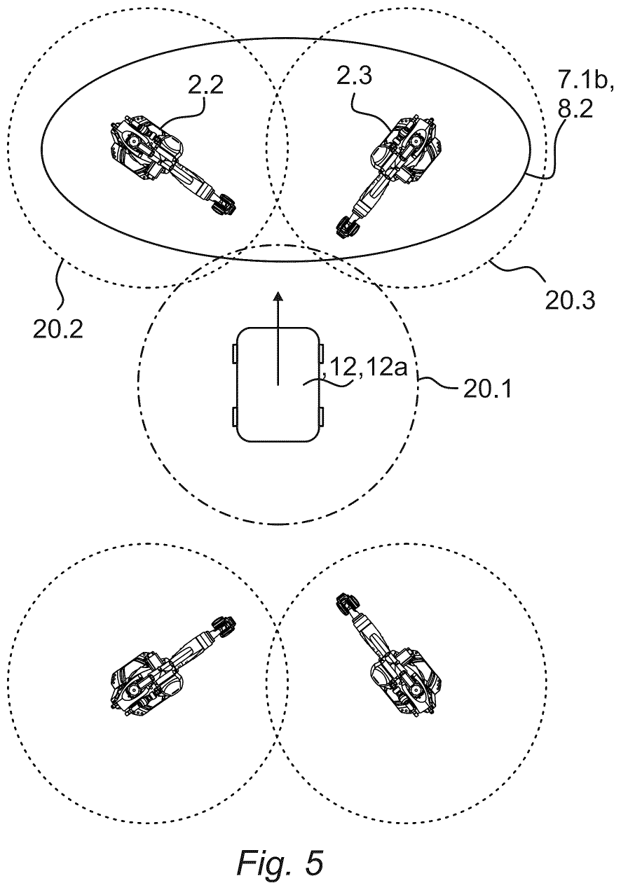

As illustrated in FIG. 5, the initialization routine can be started automatically, and the assignment of the emergency-stop device 1 to a selected range of effectiveness 7.1, 7.1a, 7.1b, 7.2, 7.2a, 7.2b can be carried out automatically, as soon as a predefined or process description-derived first protective field 20.1, e.g., of the vehicle 12a, overlaps with a predefined second protective field 20.2 of a second robot system 2.2 and/or with a predefined third protective field 20.3 of a third robot system 2.3.

The predefined first protective field 20.1 of the vehicle 12a, for example, and/or the predefined second protective fields 20.2 and third protective fields 20.3 of the second robot system 2.2 or the third robot system 2.3 can be assigned to and/or correspond to a range of effectiveness 7.1, 7.1a, 7.1b, 7.2, 7.2a, 7.2b defined in the digital process model 5.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

1. Method for assigning an emergency-stop functionality between at least one emergency-stop device (1) and at least one robot system (2.1, 2.2, 2.3), comprising the steps of:
starting an initialization routine which is designed and configured to integrate an emergency-stop device (1) assigned to the initialization routine into a safety circuit (8) of a specific robot system (2.1, 2.2, 2.3) from a number of several robot systems (2.1, 2.2, 2.3) of a common automation system (4),
retrieving data containing information about the current spatial localization and the current configuration of at least one robot system (2.1, 2.2, 2.3) of the several robot systems (2.1, 2.2, 2.3) within the common automation system (4) from a digital process model (5) of the automation system (4), wherein
the digital process model (5) contains configuration data which describe common and/or separate ranges (7.1, 7.1a, 7.1b, 7.2, 7.2a, 7.2b) of effectiveness of the several robot systems (2.1, 2.2, 2.3) within the common automation system (4),
manually or automatically assigning the emergency-stop device (1), which is to be integrated into the safety circuit (8) of a specific robot system (2.1, 2.2, 2.3) by means of the started initialization routine, to a range (7.1, 7.1a, 7.1b, 7.2, 7.2a, 7.2b) of effectiveness selected from several ranges (7.1, 7.1a, 7.1b, 7.2, 7.2a, 7.2b) of effectiveness of the digital process model,
integrating the emergency-stop device (1) into the safety circuit (8) of the robot system (2.1, 2.2, 2.3) which lies within the selected range (7.1, 7.1a, 7.1b, 7.2, 7.2a, 7.2b) of effectiveness of the digital process model (5).

2-10. (canceled)
